(19) United States
(12) Patent Application Publication
(10) Pub. No.: US 2010/0140917 A1
(43) Pub. Date: Jun. 10, 2010

(54) Vacuum fitting connection

(75) Inventors: James George Sheremeta, Shelburne (CA); Yan Feng, Mississauga (CA)

Correspondence Address: LEWIS B. STERNFELS, 3100 INGLEWOOD BOULEVARD, LOS ANGELES, CA, 90066-1062, US

(73) Assignee: Plastiflex Canada Inc., Orangeville (CA)

(21) Appl. No.: 12/592,775

(22) Filed: Dec. 1, 2009

Related U.S. Application Data
(60) Provisional application No. 61/201,098, filed on Dec. 5, 2008.

(51) Int. Cl. A47L 9/24; F16L 35/00

(52) U.S. Cl. 285/7; 285/24

(57) ABSTRACT

A vacuum connection to connect a vacuum fitting to a corrugated hose has an air tube which defines an air channel and fits into the corrugated pipe. The connecting has a securing mechanism to secure the air tube to the corrugated hose. The air tube has an outer diameter which corresponds to the inner diameter of the corrugated hose to create an air tight seal. The securing mechanism has radial projections which are radially biased towards the air tube and engage one or more of the corrugations of the corrugated pipe to secure the vacuum fitting to the corrugated pipe. When the corrugated pipe is to be removed from the fitting, the radial projections may be moved against the biasing force to disengage the corrugations and permit removal of the corrugated pipe from the fitting. The opening of the air tube has a chamfered edge to create a smooth transition from the air channel of the air tube to the corrugated pipe thereby decreasing vacuum loss, debris accumulation and excessive noise.

This application is related to and claims priority to U.S. provisional application Ser. No. 61/201,098 filed Dec. 5, 2008 entitled “VACUUM FITTING CONNECTION”, which is expressly incorporated herein by reference in its entirety.

### FIELD OF THE INVENTION

This invention relates to vacuum cleaning systems. In particular, the invention relates to connections for vacuum fittings to be used with central vacuum systems having corrugated hoses connecting vacuum inlet valves to the central vacuum source.

### BACKGROUND OF THE INVENTION

Vacuum cleaning systems have a central vacuum source which is connected to various vacuum inlets located remotely throughout a structure, such as a house. In the past central vacuum systems have generally used rigid Polyvinyl Chloride (PVC) tubing and fittings to connect the vacuum source to the various vacuum inlets. PVC tubing is generally smooth on the inside so as to avoid vacuum loss or debris accumulation, resulting from the air flowing through the PVC tubing. Furthermore, the connection between the PVC tubing and various fittings in the central vacuum system are generally made with adhesives such as glue, solvent based glue, or solvent based cement so that they are airtight and rigid. Furthermore, vacuum fittings for rigid PVC tube can be moulded to fit seamlessly around the circumference of the PVC tubing to avoid noise as well as debris accumulation at the intersection between the PVC tube and the connection point of the fittings for rigid PVC tube.

However, rigid PVC tube suffers from several disadvantages. One of these is that the rigid PVC tube must be oriented around obstructions. This generally necessitates a large number of individual fittings having unique shapes and orientations that are assembled with the PVC tubing like a “three dimensional jigsaw puzzle” to avoid solid obstructions. Furthermore, because PVC is permanently glued in place and to ensure that the resulting “jigsaw puzzle” of PVC tubing and fittings will in fact overcome an obstruction, a “dry run” is generally performed without adhesive. In a “dry run” each of the fittings and individual cut links of PVC rigid tubing are put together without adhesive to see if the obstruction can be overcome. There is also labour time associated with measuring and cutting the pieces of rigid PVC tubing to overcome an obstruction. There may also be some waste of PVC tubing if they are cut incorrectly. Once the dry run is complete, and the installer is satisfied that the obstruction can be overcome, the fittings and pipe are then disassembled and then reassembled with glue, other adhesive or solvents to create the final non-releasable airtight connection.

It is apparent that this “dry run”, and the subsequent disassembling and reassembling with glue or other solvents, can be very time consuming and labour intensive. Furthermore, installers must keep a large number of unique fittings such as elbows, of different shape and sizes to be able to accommodate various obstructions, throughout the structure into which the vacuum system is being installed.

In the past, non-rigid plastic hoses had been proposed. However, non-rigid plastic hose pipes, such as corrugated hose, present other challenges. For instance, use of corrugated hose when cut may have a rough edge such that it is difficult to create a smooth transition between the end of a cut hose and a vacuum fitting connection. To overcome this difficulty, prior art devices, such as those disclosed in Dutch utility model NL C 1027942 has proposed a coupling which has a collar that goes on the end of a cut corrugated hose to avoid loss of vacuum. While this has some advantages, it suffers from the disadvantage that the use of the collar increases the cost of the overall device. Furthermore, an adhesive is still used which may still require a “dry run”. The use of the adhesive also causes environmental and health concerns.

Other flexible hose vacuum systems have also relied on a friction fit. While a friction fit may be practical for the “do it yourself” market, it is less practical for the commercial market where various trades may be working on the same structure and such that one tradesperson, such as an electrician who installs electrical cable, may damage or knock a friction fit vacuum fitting connection out of place. Furthermore, this may not be noticed until after other trades have completed their work, such as installing and finishing drywall, increasing the cost of correcting the damage.

Accordingly, there is a need in the art for a more robust vacuum connection to releasably connect a vacuum fitting to corrugated pipe. There is also a need in the art for vacuum connections which provide a smooth transition from the corrugated pipe to the fitting in order to avoid loss or vacuum, avoid increasing noise and debris accumulation.

### SUMMARY OF THE INVENTION

Accordingly, it is an object of this invention to at least partially overcome some of the disadvantages of the prior art. Also, it is an object of this invention to provide an improved type of vacuum fitting connection to facilitate connecting a vacuum fitting to a corrugated hose. Furthermore, there is a need in the art for a connection to releasably connect a vacuum fitting to a corrugated hose to permit easy installation and avoid the time loss associated with “dry run” connections of various components. There is also a need in the art to avoid the use of adhesives such as glues and solvents which may have detrimental environmental and health effects.

Accordingly, in one of its aspects, this invention provides a connection to connect a vacuum fitting to a corrugated hose having an inner diameter and corrugations on the outer surface, said connection comprising: an air tube defining an air channel and having a first opening, said air tube having an outer diameter corresponding to the inner diameter of the corrugated hose to create an air tight seal when the first opening of said air tube is inserted into the corrugated hose and the air channel is in vacuum communication with the corrugated hose; a securing mechanism for releasably securing the vacuum fitting to the corrugated hose, said securing mechanism releasably engaging at least one corrugation of the corrugated hose to secure the vacuum fitting to the corrugated hose when the first opening of the air tube is inserted into the corrugated hose.

In a further aspect, the present invention provides a vacuum fitting for a central vacuum system, said fitting comprising: a first end having a first connection for a corrugated hose, said connection comprising: (a) an air tube defining an air channel and having a first opening, said air tube having an outer diameter corresponding to an inner diameter of the corrugated hose to create an air tight vacuum seal when the first opening of said air tube is inserted into the corrugated hose and the air channel is in vacuum communication with the corrugated hose; (b) a first securing mechanism for releasably securing the first end of the vacuum fitting to the corrugated hose, said first securing mechanism releasably engaging at least one corrugation of the corrugated hose to secure the first end of the vacuum fitting to the corrugated hose when the first opening of the air tube is inserted into the corrugated hose; a second end of the fitting, remote from the first end, and, in vacuum communication with the first end through the air channel of the air tube.

Further aspects of the invention will become apparent upon reading the following detailed description and drawings, which illustrate the invention and preferred embodiments of the invention.

### BRIEF DESCRIPTION OF THE DRAWINGS

In the drawings, which illustrate embodiments of the invention:

FIG. 1(a) is a general representation of a conventional central vacuum system using PVC tubing;

FIG. 1(b) is a perspective representation of a conventional central vacuum system using rigid PVC tubing to overcome an obstacle;

FIG. 2(a) is a general representation of a central vacuum system using corrugated hose according to one embodiment of the present invention;

FIG. 2(b) is a perspective representation of a central vacuum system using corrugated hose to overcome an obstacle;

FIG. 3 is a perspective illustration of a corrugated hose comprising a double wall blow moulded hose according to one preferred embodiment of the present invention;

FIG. 4 is a cross section view of the double wall blow moulded hose of FIG. 3;

FIG. 5(a) is a perspective representation of a connector vacuum fitting comprising a connection according to one embodiment of the present invention;

FIG. 5(b) is a perspective representation of a T-shape vacuum fitting comprising a connection according to one embodiment of the present invention;

FIG. 5(c) is a short 90° connection according to one embodiment of the present invention;

FIG. 6(a) is PVC/corrugated adaptor according to one embodiment of the present invention;

FIG. 6(b) is a perspective view of the PVC/corrugated adapter of FIG. 6(b) without the corrugated hose or the rigid PVC tubing inserted therein;

FIG. 7(a) illustrates a perspective view of a vacuum fitting having a connection according to one embodiment of the present invention;

FIG. 7(b) is a perspective view of the fitting shown in FIG. 7(a) with the corrugated hose removed;

FIG. 7(c) is a cross-section of FIG. 7(a);

FIG. 7(d) is a detailed view of the transition phase of the connection shown in FIG. 7(b);

FIG. 8(a) illustrates a perspective view of a vacuum fitting having a connection according to a further embodiment of the present invention;

FIG. 8(b) is a perspective view of the fitting shown in FIG. 8(a) with the corrugated pipes removed;

FIG. 8(c) is a cross-section of FIG. 8(a);

FIG. 9(a) illustrates a perspective view of a vacuum fitting having a connection according to a further embodiment of the present invention;

FIG. 9(b) is a cross-section of FIG. 9(a);

FIG. 10(a) illustrates a perspective view of a vacuum fitting having a connection according to a further embodiment of the present invention;

FIG. 10(b) is a cross-section of connection show in FIG. 10(a) connected to a corrugated hose;

FIG. 11(a) illustrates a perspective view of a vacuum fitting having a connection according to a further embodiment of the present invention;

FIG. 11(b) is a perspective view of the fitting shown in FIG. 11(a) with the corrugated hoses removed;

FIG. 12(a) illustrates a perspective view of a vacuum fitting having a connection according to a further embodiment of the present invention;

FIG. 12(b) is a perspective view of the fitting shown in FIG. 12(a) with the corrugated hoses removed;

FIG. 12(c) is a cross-section of FIG. 12(a) with the fitting connected to hoses;

FIG. 13(a) illustrates a perspective view of a vacuum fitting according to a further preferred embodiment of the present invention;

FIG. 13(b) is a side elevational view of the vacuum fittings from FIG. 13(a);

FIG. 13(c) is a side elevational view of the vacuum fitting show in FIG. 13(b) with a hose connected to one end;

FIG. 13(d) is a detailed drawing of a part of the connection of the vacuum fitting shown in FIG. 13(c);

FIG. 14(a) illustrates a perspective view of a 2-piece connection according to a further embodiment of the present invention;

FIG. 14(b) illustrates a first part having a 2-piece connection to engage the corrugated hose shown in 14(a);

FIG. 14(c) illustrates the second part of the 2-piece two parts of FIGS. 14(a) and 14(b) connected together; and

FIG. 14(d) illustrates the connector shown in FIGS. 14(a) to 14(c) connected to a corrugated pipe.

### DETAILED DESCRIPTION OF THE PREFERRED EMBODIMENTS

Preferred embodiments of the invention and its advantages can be understood by referring to the present drawings. In the present drawings, like numerals are used for like and corresponding parts of the accompanying drawings.

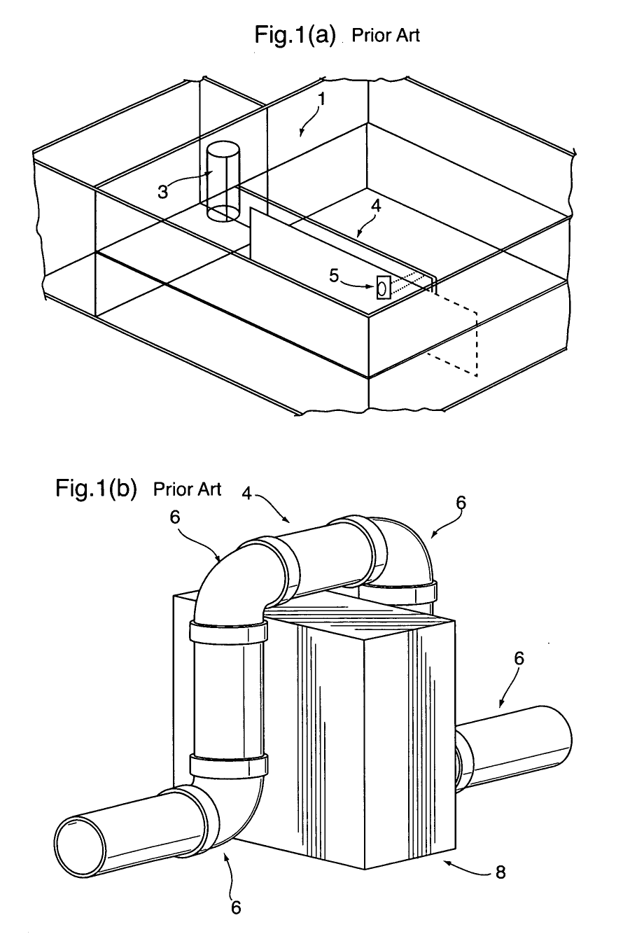

FIG. 1(a) illustrates a conventional central vacuum system, as shown generally by reference numeral 1, having rigid tubes shown generally by reference numeral 4. As illustrated in FIG. 1, the vacuum system 1 comprises a central vacuum source, shown generally by reference numeral 3, which generates a vacuum source. The rigid tubes 4, which are generally PVC tubing, then connect the vacuum source 3 to at least one, and likely several, inlet valves 5 throughout the structure to permit remote access to the vacuum generated by the central vacuum source.

FIG. 1(b) illustrates the conventional central vacuum system 1 using rigid tubes 4 to overcome an obstacle 8. As is apparent from FIG. 1(b), four rigid tubing vacuum fittings 6 would be required to overcome the single obstacle 8. Moreover, as illustrated in FIG. 1(b), three separate links of the rigid pipe 4 would need to be measured, cut and assembled, usually in a “dry run”, and then disassembled, and then reassembled together with an adhesive.

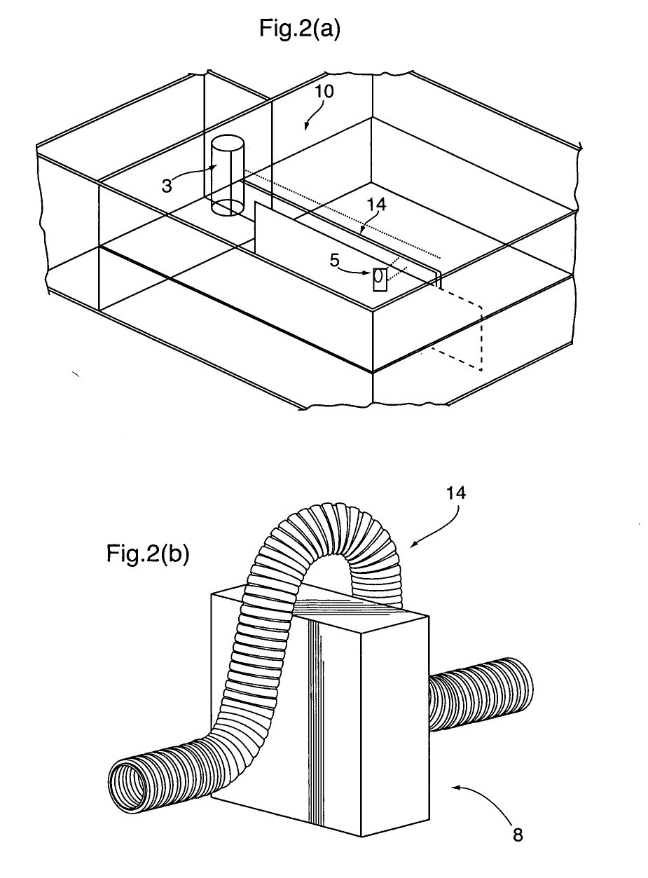

FIG. 2(a) is a symbolic illustration of a central vacuum system, according to one embodiment of the present invention, shown generally by reference numeral 10 comprising corrugated hose 14. As shown in FIG. 2, the corrugated hose 14 is used to connect the central vacuum source, shown generally by reference numeral 3, to vacuum inlets 5 throughout the structure. It is understood that the central vacuum system 10 may have several links of corrugated hose 14, all leading to the same vacuum source 3. While not clearly illustrated in FIG. 2(a), the corrugated hose 14 could be connected with vacuum fittings 300 having one or more of the connections 100 of the present application. It is further understood that the vacuum system 10 may be installed in any type of structure, such as a house, apartment, residential condominium, commercial condominium or industrial unit. There is no restriction on the location or structure where the central vacuum system 10 may be installed.

It is also understood that the vacuum system 10 may have both corrugated hose 14, and also in some cases rigid PVC tubing 4. This could occur for example if an existing system having rigid PVC tubing 4 is retrofitted in part with corrugated hose 14 and/or an expansion is made onto an existing building having PVC tubing 4.

FIG. 2(b) illustrates a corrugated hose 14 overcoming an obstacle 8. As illustrated in FIG. 2(b), the hose 14 is sufficiently flexible to simply overcome most obstacles 8 without the use of any fittings. This decreases the installation costs both from the perspective of parts and also from the perspective of labour.

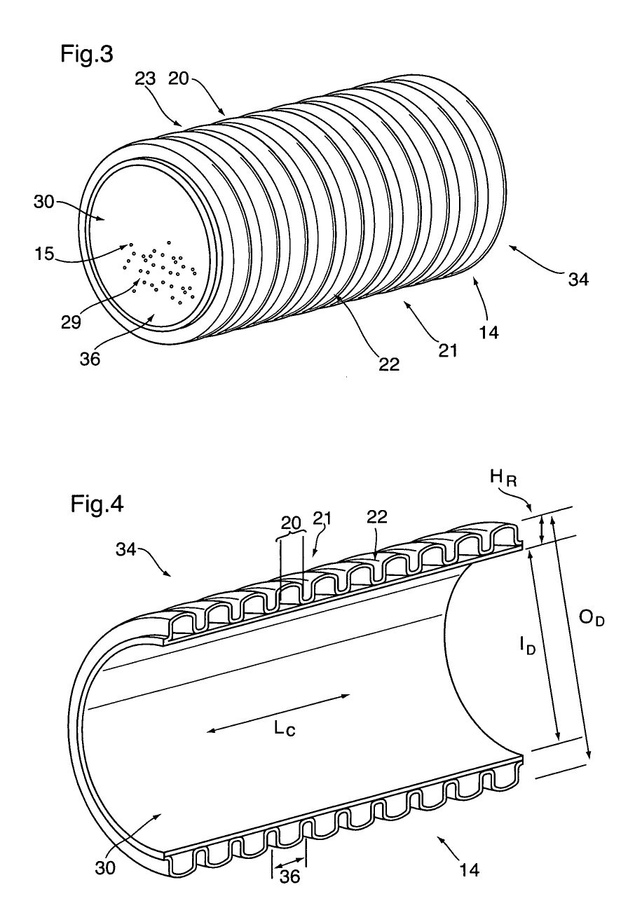

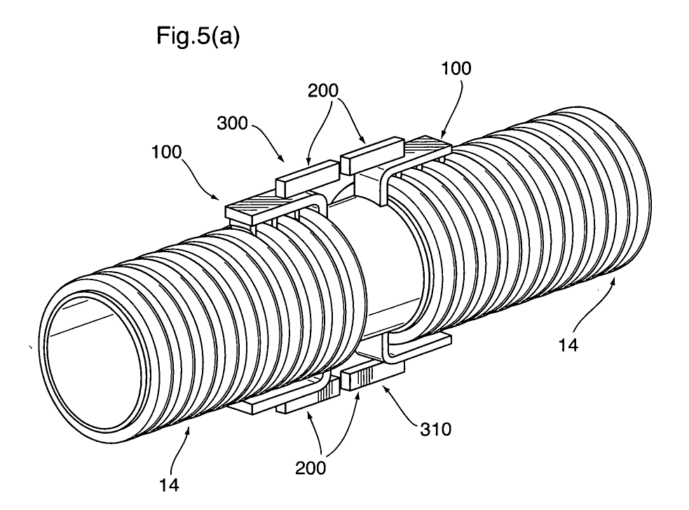

FIG. 3 and FIG. 4 illustrate a perspective view and a cross-section view, respectively, of a corrugated hose 14 which may be used in the corrugated vacuum system 10 according to one embodiment of the present invention. In a preferred embodiment, the corrugated hose 14 constitutes a double wall blow molded hose 34. In this process, the outer surface 23 of the corrugated hose 4 will have corrugations 20 comprising ridges 21 and troughs 22, but, the inner surface 30 of the corrugated hose 14 will be substantially smooth facilitating the easy flow of air and avoiding vacuum loss. The substantially smooth walled inner surface 30 also facilitates the flow of debris shown generally by reference numeral 36 entrained in the air flow to decrease debris accumulation. The hose 14 will, of course, have an opening 15 through which air and debris may travel. The hose 14 also defines a hose air channel, shown generally by reference numeral 31.

As best illustrated in FIG. 4, the flexible hose 14 will have an outer diameter O_{D\} and a inner diameter I_{D}. As also best illustrated in FIG. 4, each of the ridges 21 will have a height H_{R} extending from the top of the trough 22 to the top of the ridge 21. The distance separating the commencement of one ridge 21 from the commencement of another ridge 21 is identified generally by reference numeral 36 in FIG. 4. As illustrated, this distance 36 extends along a longitudinal axis L_{C} of the hose 14 for a distance 36 representing the longitudinal width of one corrugation 20 including the width of one ridge 21 and one trough 22, along the longitudinal axis L_{C}. It is understood that the longitudinal axis L_{C} may not be straight but could bend or curve reflecting the flexible nation of the hose 14.

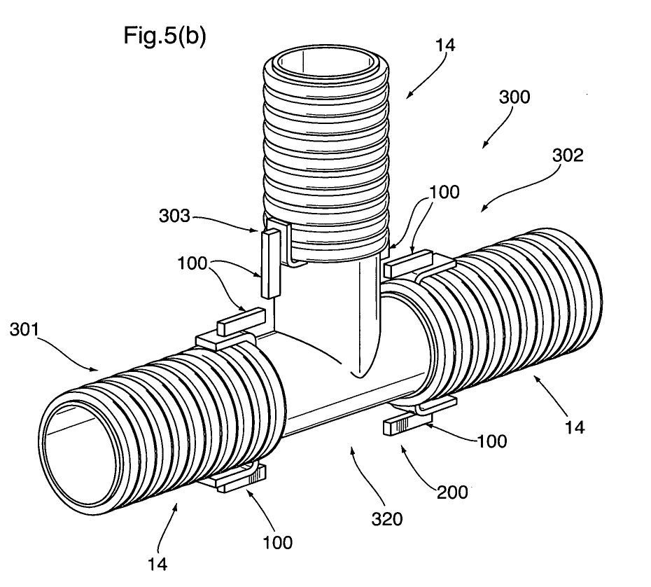

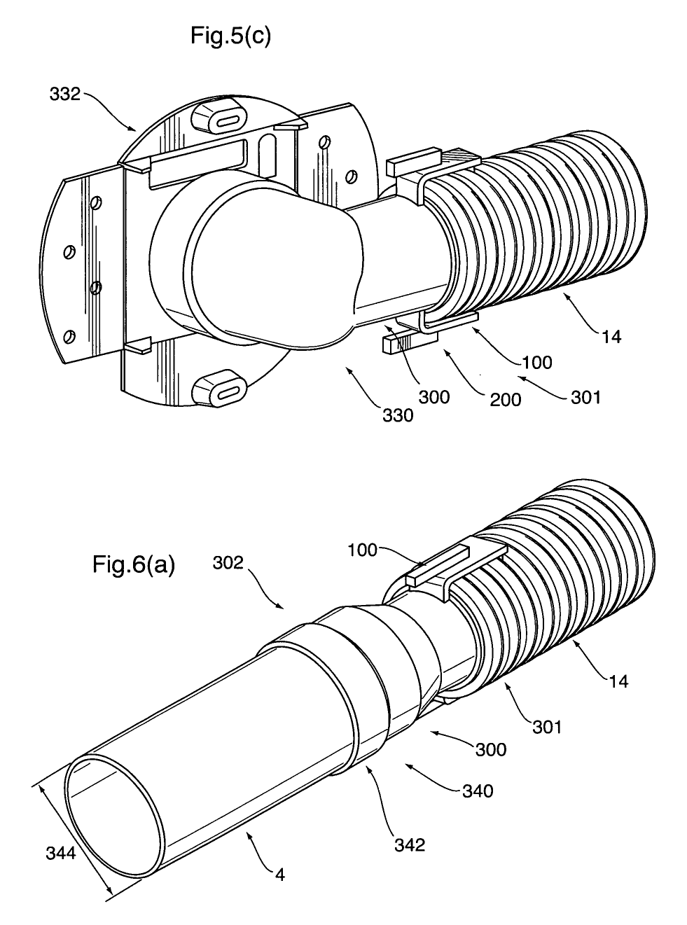

It is understood that the hose 14, while it can overcome obstacles 8, will eventually need to be connected to other elements, such as other hoses 14, inlet valves 5 and also in some applications to PVC tube 4, to name but a few potential applications. To accomplish this, various vacuum fittings 300, such as those illustrated in FIGS. 5(a), 5(b), 5(c) and 6(a), 6(b) and 6(c) may be provided. In particular, FIG. 5(a) illustrates a vacuum fitting 300 which is a connector or straight connection 310 which can be used if two hoses 14 are to be fitted together. As illustrated in FIG. 5(a), the fitting 300 has a first end 301 and a second end 302, and a connection 100 to connect the fitting 300 to the corresponding hoses 14. The connection 100 will be discussed more fully below.

FIG. 5(b) shows a further vacuum fitting 300 which is a T-shaped connector 320. As is apparent from FIG. 5(b), the T-shaped connector connects three hoses 14 together in a “T” shape to permit vacuum communication between all three hoses 14. Generally, one of the hoses 14 will be connected to a vacuum source 3 and the other two hoses 14 will be connected to other elements in the system 10 such as vacuum inlet valves 5. The T-shaped connector 320 has a first end 301, a second end 302 and a third end 303, with each end 301, 302, 303 having a connection 100 to connect the vacuum fittings 320 to each of three hoses 14. It is understood that other vacuum fittings 300 having three ends 301, 302, 303, such as Y-shaped connectors (not shown) and could utilize the connection 100 of the present invention.

FIG. 5(c) shows a vacuum fitting 300 which in this embodiment is a short 90° adaptor 330. The short 90° adaptor 330 has a connection 100 to connect the short 90° adaptor 330 to the hose 14. In the embodiment illustrated in FIG. 5(c), the short 90° adaptor 330 is connected to the mounting plate 332 which then may be mounted to a wall and could eventually form a part of vacuum inlet 5.

FIG. 6(a) shows a particular type of vacuum fitting 300 which is a PVC tube/corrugated hose adaptor 340. This PVC/corrugated adaptor 340 has a connection 100 at a first end 301 for connecting the vacuum fitting 300 to a hose 14 and a PVC tube connector 342 at the other end 302 for connection to a rigid tube 4. This type of vacuum fitting 300 may be used, for instance, when a conventional vacuum system 1 is to be retrofitted or connected to a hose central vacuum system 10. This PVC/corrugated adapter 340 could also be used if, for whatever reason, an existing hose based system 10 is to be connected to a rigid tube 4 for a particular application.

As also illustrated in FIG. 6(a), the PVC tube 4 has an outer diameter 344. The outer diameter 344 corresponds to and fits into the inner diameter 343 of the PVC tube connector 342. An adhesive, such as glue or solvent based cement, would then be used to connect the rigid tube 4 to the PVC tube connector 342 of the PVC/corrugated adaptor 340, illustrated in FIGS. 6(a) and 6(b). The corrugated hose 14 would then be connected to the first end 301 of the PVC/corrugated adapter 340 using the connection 100 according to various embodiments of the present invention as discussed more fully below.

It is understood that the connection 100 discussed below and the subject of this application could be used with any of the vacuum fittings 300 illustrated above including the straight connector 310, and the T-shaped connection 320, the short 90° adaptor 330 and the PVC/corrugated adaptor 340 (for connection of the hose 14 to the first end 301 and not the PVC tube connector 342 at the second end 302 of adaptor 340) as well as any other type of vacuum fitting 300 which may be used in the vacuum system 310.

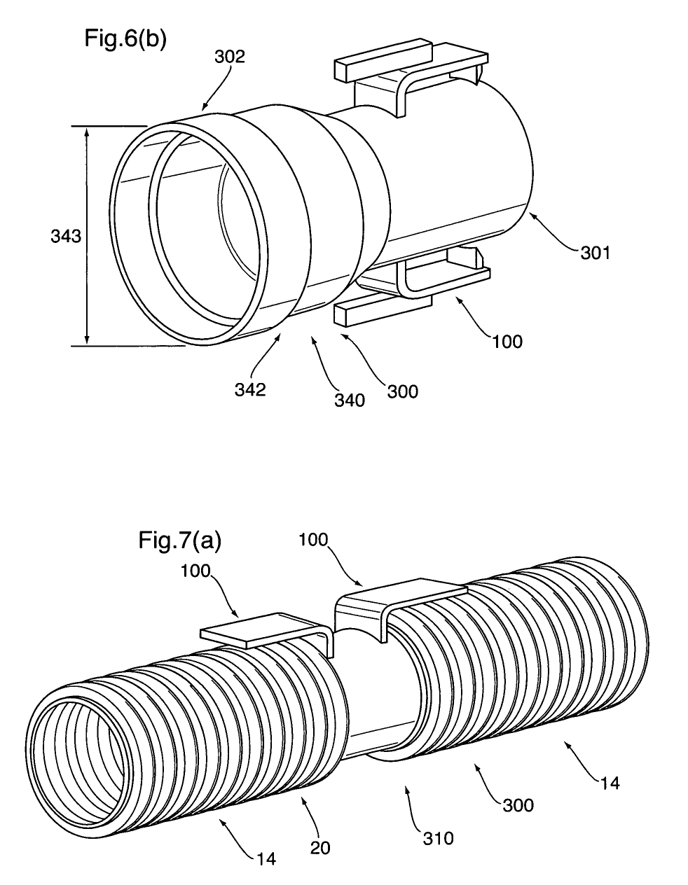

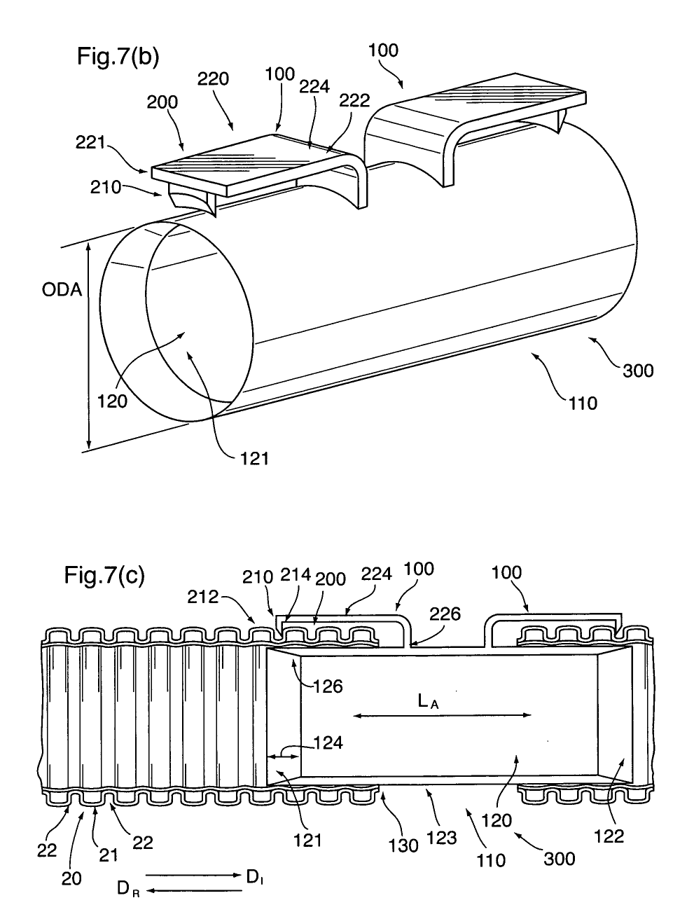

FIG. 7(a) illustrates a connector 100 according to one embodiment of the present invention. It is understood that the connection 100 can be used with any type of vacuum fitting 300 to connect a corrugated hose 14 to the vacuum fitting 300, including the vacuum fittings 310, 320, 330 and 340 discussed above. For ease of illustration, the vacuum fitting 300 in FIG. 7(a) is a straight connector 310 connecting two hoses 14. The straight connector 310 therefore has connections 100 at the first end 301 and the second end 302 respectively to connect to separate hose 14 lengths to the fitting 300. It is understood that if the vacuum fitting 300 was a T-shaped connector 320 there would be three separate connections 100, one for each hose 14.

As illustrated in FIGS. 7(a), 7(b) and 7(c), the connection 100 comprises an air tube 110 which defines an air channel 120 between a first opening 121 and a second opening 122. It is understood that if the vacuum fitting 300 was a T-shaped vacuum fitting 330, there would be an additional third opening (not shown).

The air tube 110 extends along a longitudinal axis, identified generally by reference numeral L_{A}, and, has an outer diameter shown best in FIG. 7(b), by reference numeral O_{DA}. Furthermore, it is understood that the outer diameter O_{DA} of the air tube 110 will correspond to the I_{DC} of the hose 14. In this way, an airtight seal 130 will be created between the outer surface 123 of the air tube 110 and the inner surface 30 of the corrugated hose 14. It is also understood that the hose 14 may also have some radial resiliency such that if the air tube 110 outer diameter O_{DA} is about the same or slightly greater than the corrugated hose 14 inner diameter I_{DC}, then the hose 14 may stretch, and, the air tight seal 130 may be improved. It is also understood that the air tight seal 130 may not be a perfect air tight seal and some leakage could still exist as would be expected. Rather, the air tight seal 130 would be a substantial air tight seal to preserve most of the vacuum generated by the vacuum source 3.

The connection 100 also comprises a securing mechanism, shown generally by reference numeral 200. The securing mechanism releasably secures the vacuum fitting 300 to the corrugated hose 14. Preferably, the securing mechanism releasably engages at least one corrugation 20 of the corrugated hose 14 to releasably secure the vacuum fitting 300 to the corrugated hose 14 when the tube 110 is inserted into the corrugated hose 14.

The securing mechanism 200 preferably comprises at least one, and preferably two or three, radials projections, shown generally by reference 210. The radial projections 210 project radially inwardly towards the longitudinal access L_{A} of the air tube 110 and engages at least one corrugation 20 on the outer surface 23 of the corrugated hose 14 to releasably secure the vacuum fitting 300 to the hose 14. The radial projections 210 preferably fit into at least one trough 22 of at least one corrugation 20 in the outer surface 23 of the corrugated hose 14 to secure the vacuum fitting 300 to the corrugated hose 14.

Preferably, the radial projection 210 is carried by a resilient member 220 which biases the radial projection 210 towards the air tube 110. It is understood that where the corrugations 20 of the corrugated pipe 14 define ridges 21 and troughs 22, the resilient member 220 may bias the radial projection 210 into one of the troughs 22 of a corrugation 20 on the outer surface of the corrugated hose 14. For greater clarity, it is not necessary that the resilient member 220 bias the radial projections 210 against the air tube 110. Rather it is sufficient, and sometimes preferred, if the resilient member 220 resiliently holds the radial projection 210 a known distance above the air tube 110, but into the trough 22 of the corrugation 10.

In a preferred embodiment, as illustrated in FIGS. 7(a), 7(b) and 7(c), the resilient member 220 may comprise having a first end 221 and a second end 222 as illustrated best in FIG. 7(b). In a preferred embodiment, the resilient member 220 comprises an arm 224, but other configurations are possible as discussed more fully below. The resilient member 220 will generally carry the radial projections 210.

Preferably, the radial projection 210 is carried at the first end 221 of the resilient member 220 and the first end 221 is proximate the first opening 121 of the air tube 110. The second end 222 of the resilient member 220 is preferably fixed to the air tube 110. In this way, the resilient member 220 may resiliently bias the radial projection 210 towards the longitudinal access L_{A} of the air tube 110, such as a known distance above the air tube 10, and preferably into a rough 22.

As illustrated in FIG. 7(c), the radial projection 210 preferably has a chamfered edge 212 and a locking edge 214. The chamfered edge 212 preferably engages the ridges 21 of the corrugations 10 when the corrugated hose 14 is moved in an insertion direction, shown generally by reference number D_{I} in FIG. 7(c) representing the direction of relative movement of the hose 14 and the air tube 110 when the air tube 110 is inserted into the hose 14. Accordingly, the chamfered edge 212 assists in causing the ridges 21 of each corrugation 20 to resiliently move the radial projection 210 in order to permit the insertion of the air tube 110 into the hose 14. As illustrated in FIG. 7(c), the resilient member 220 will rotate away from the longitudinal axis L_{A} of the air tube 110 about the second end 222 as the corrugations 20 engage the chamfered edge 212 when the hose 14 moves in the insertion direction D_{L} relative to the air tube 110.

The radial projection 210 may also have a locking edge 214 which engages the ridges 21 of the corrugation 20 when the corrugated hose 14 is moved in a removal direction, shown generally by reference numeral D_{R}, representing the direction of relative movement of the hose 14 with respect to the air tube 110 to remove the air tube 110 from the hose 14. The locking edge 214 engages the ridges 21 of the corrugations 20 on the outer surface 23 of the hose 14 to resist movement of the hose 14 in the removal direction D_{R}. It is understood that with sufficient force in the removal direction D_{R} the locking edge 214 may be overcome, but the locking edge 214 is intended to provide more resistance to movement in the removal direction D_{R} than the chamfered edge 212 provides in the insertion direction D_{I} to make insertion of first opening 21 of the air tube 110 into the hose 14 easier than removal of the air tube 110 from the hose 14.

If the air tube 110 is to be removed from the hose 14, the radial projection 210 can be moved from the trough 22 against the force of the resilient member 220 to permit movement of the hose 14 in the removal direction D_{R} and removal of the air tube 110 from the hose 14. The radial projection 210 can be removed from the trough 22 by moving the radial projection 210 from the trough 22 against the resilient biasing force of the resilient member 220. In a preferred embodiment, discussed more fully below the radial projection 210 may be removed from the groove 22 with the single hand of the user to permit the other hand of the user to perform other functions, such as moving the hose 14 in the removal direction D_{R}.

To facilitate air flow through the air tube 110 and in particular from the first opening 121 to the hose 14, the air tube 110 preferably comprises a transition phase 124 shown best in FIG. 7(c). The transition phase 124 preferably has a chamfered edge 126. The chamfered edge 126 in the preferred embodiment has an angle α with respect to the longitudinal axis L_{A} and/or the outer surface 123 of the air tube 110. Preferably the angle α is less than 60°. More preferably, the angle α of the chamfered edge 126 is less than 30°, and still more preferably less than 20°.

It is understood that the angle α of the chamfered edge 126 is designed to provide a smooth transition of the air flow from the air channel 31 of the hose 14 to the air channel 120 of the air tube 110. This is the case whether the air flow is into the connection 100 or out of the connection 100. For example, as illustrated in FIGS. 7(a), 7(b), 7(c) and 7(d), the same connection 100 may be present at both ends 301 and 302 of the fitting 300 such that the air flow would be into the air tube 110 at one end 301, 302 of the fitting 300, and, out of the air tube 110 at the other end 302, 301 of the fitting 300. In both cases, a transition phase 124 with a chamfered edge 126 having an angle α with respect to the outer surface 123 of less than 60° would improve the air flow. Furthermore, debris may accumulate at the junction between the hose 14 and the air tube 110. By having a chamfered edge 126 of less than 60° and more preferably less than 30°, debris accumulation at the junction of the air tube 110 and the hose 14 may be decreased. Furthermore, as illustrated above with respect to FIGS. 1(a), 1(b), 2(a) and 2(b), much fewer vacuum fittings 300 would be required in the corrugated central vacuum system 10 as opposed to the conventional central vacuum system 1, such that fewer junctions would occur simply because fewer vacuum fittings 300 would be used in the corrugated system 10.

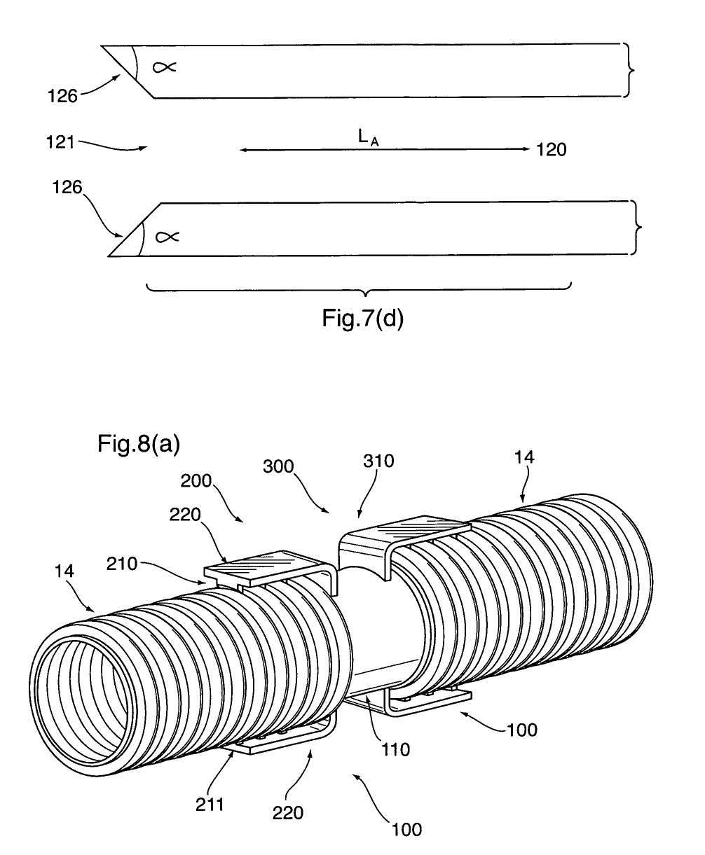

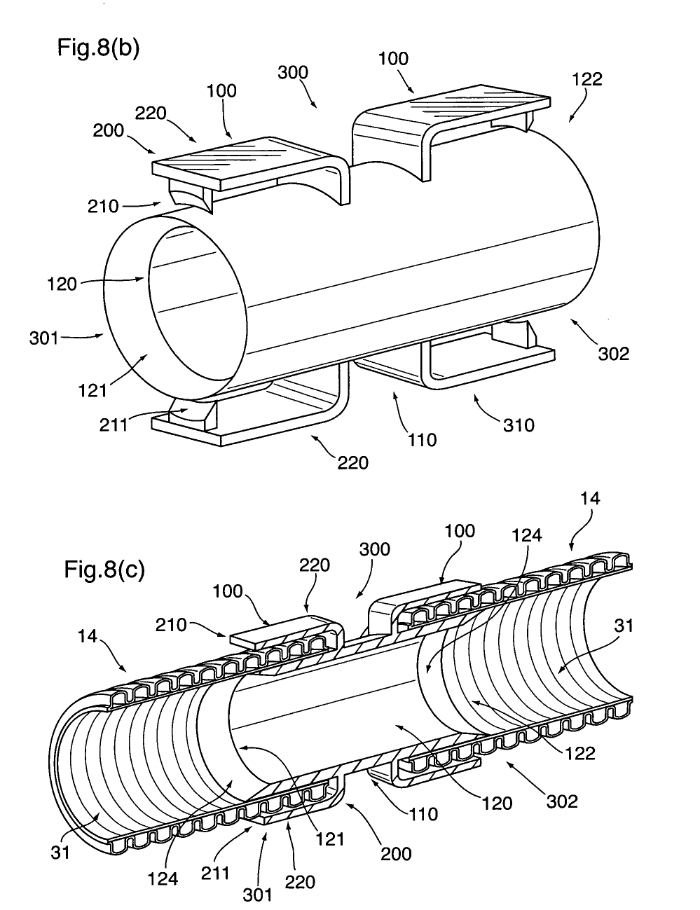

FIG. 8(a) shows a further preferred embodiment of the present invention. In FIG. 8(a), the connection 100 has an opposed radial projection 211 which is opposed to the radial projection 210 on the other side of the longitudinal axis L_{A} of the air tube 110. The opposed radial projection 211 may have the same structure as the radial projection 210 as discussed above. The opposed radial projection 211 increases the ability of the securing mechanism 200 to releasably secure the vacuum fitting 300 to the corrugated hose 14. It is understood that the opposed radial projection 211 may be carried by another resilient member 220 and resiliently biased towards longitudinal axis L_{A} of the air tube 110. Furthermore, as indicated above, it is sufficient, and sometimes preferred, if the resilient member 220 biases the opposed radial projection 211 to a known position above the air tube 110 and, more preferably, into a trough 22 of at least one corrugation 20.

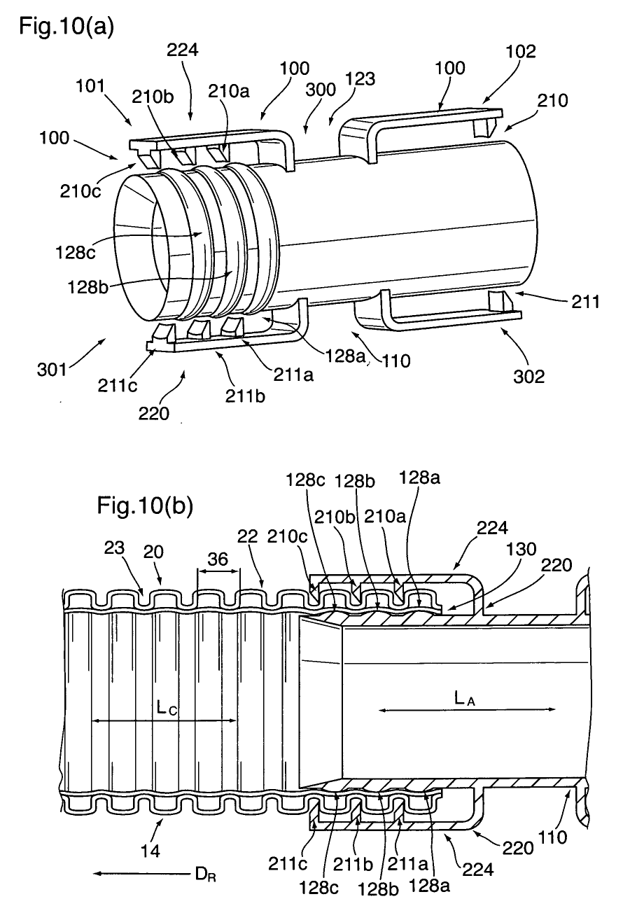

As also illustrated in FIGS. 8(a) and 8(b), the vacuum fitting 300 also has a connection 100 at the second end 302 of the fitting 300. This is the case because the fitting 300 is a connector 310 to connect one hose 14 to another hose 14. It is apparent from FIGS. 8(a) and 8(b) that the first connection 100 at the first end 301 is identical to the second connection 100 of the second end 302 of the fitting 300. It is understood however that the connections 100 could be of different form, as illustrated in other drawings such as in FIG. 10(a) shown bellow. Furthermore, in a preferred embodiment, the fitting 300 will have a single air tube 110 which is shared by both the first connection 101 of the first end 301 and the second connection 102 of the second end 302. Furthermore, the first opening 121 of the first connection 101 at the first end 301 will coincide with the second opening 122 of the second connector 102 at the second end 302 and visa versa. In other words, the openings, 121, 122 of the corresponding connector 101,102 which is inserted into the hose 14 would be in vacuum connection with the other opening 122, 121 of the other connection 102, 101 inserted into the other hose 14. In any event, the first opening 121 of the air tube 120 will be in vacuum connection with the second opening 122 and, depending on the nature of the vacuum fitting 300, the air tube 110 may be used to connect two hoses, or, in the case of the t-shaped connector 320, may be used to connect three hoses 14 together. Furthermore, other vacuum fittings 300 having four connections 100 (not shown) in a cross configuration connecting to four hoses 14 could also be used having connections 100 according to one or more embodiments of the present invention. In addition, other vacuum fittings 300 in the form of manifolds (not shown) connecting to more than four hoses 14 could also be used with the connection 100 according to one or more embodiments of the present invention.

As illustrated in FIG. 8(c), the two connections 100 at the two ends 301, 302 of the fitting 300 both have a transition phase 124 with a chamfered edge 126. This is to facilitate air flow from the air channel 120 of the air tube 110 to the air channel 31 of each of the hoses 14. The transition phase 124 will facilitate air flow from the air channel 31 of the hoses 14 to the air channel 120 of the air tube 110 regardless of the direction of the flow of air. In other words, whether the air flow is entering the first opening 121 or exiting the first opening 121, the same transition phase 124 will facilitate the flow of air and also decrease debris accumulation. Furthermore, by having the same transition phase 124 at both the first end 301 and the second end 302 of the fitting 300, the fitting 300 can be completely symmetrical thereby improving the ease of installation and decreasing the number of fittings 300 required for any given system 10.

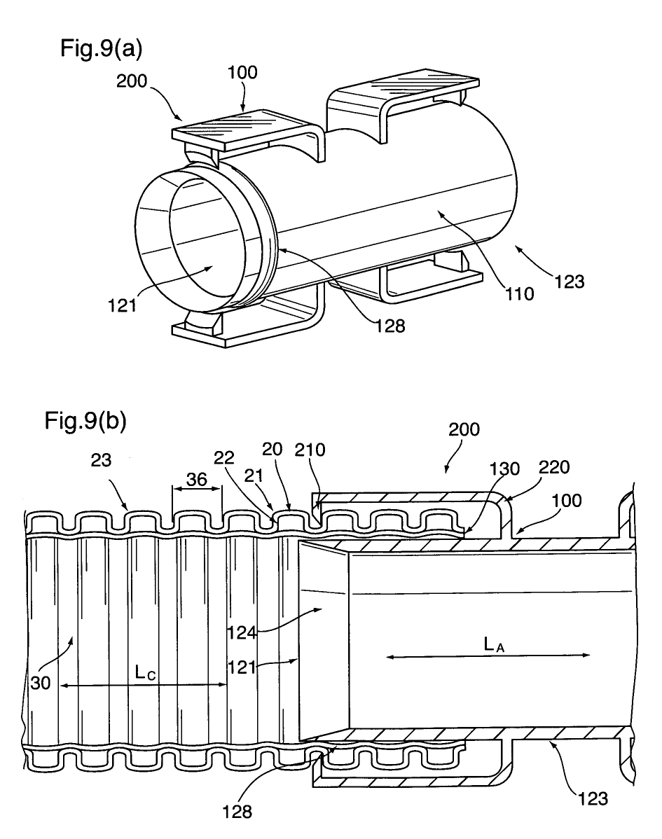

FIGS. 9(a) and 9(b) show a further preferred embodiment of the present invention having at least one ring 128 on an external surface 123 of the air tube 110. The ring 128 preferably deforms the inner surface 30 of the hose 14 at a location corresponding to the ridge 21 of a corrugation 20 on the outer surface 23 of the corrugated hose 14. To accomplish this, it is preferred that the distance between the radial projection 210 and the axial position of the ring 128 corresponds to one half the width 36 of a corrugation 20. In this way, when the radial projection 210 engages a trough 22 of a corrugation 20, the ring 128 will be deforming the inner surface 30 of the hose 14 at a longitudinal position corresponding to the ridge 21. The ring 128 may improve the air tight seal 130. The ring may also better secure the hose 14 onto the air tube.

In a further preferred embodiment, as illustrated in FIGS. 10(a) and 10(b) two, three or in some cases more rings 128a, 128b, and 128c may be on the outer surface 123 of the tube 110. The multiple rings 128a, 128b, and 128c perform the same function as the single ring 128 in FIG. 9(a), namely to better secure the hose 14 onto the air tube 110, as well as improve the air tight seal 130.

FIGS. 10(a) and 10(b) also show multiple radial projections 210a, 210b and 210c as well as multiple opposed projections 211a, 211b and 211c. It is understood that these multiple projections 210a, 210b and 210c and 211a, 211b and 211c further improve the connection 100 by increasing the resistance to relative movement of the hose 14 to the air tube 110 in the removal direction D_{R}.

As illustrated in FIG. 10(b), rings 128a, 128b, and 128c will deform the inner surface 30 of the corrugated hose of a longitudinal position on the longitudinal axis L_{c} of the corrugated hose corresponding to a ridge 22 on the outer surface 23. As with the single ring 128, this could be accomplished by having each of the rings 128a, 128b, and 128c half the distance 36 from the corresponding radial projection 210a, 210b, 210c.

It is also understood that by this arrangement, each of the rings 128a, 128b, and 128c will also be separated from each other by a distance 36 corresponding to the width of a corrugation 20 of the hose 14.

It is also apparent from FIGS. 10(a) and 10(b) that the first connection 100 of the first end 301 (shown by reference numeral 101) of the fitting 300 is different from the connection 100 at the second end 302 (shown by reference numeral 102). Accordingly, the connections 101, 102 at the ends 301, 302 of the vacuum fitting 300 may not be identical, but could have similar characteristics such as the radial projections 210 and the opposed radial projections 211. The lack of rings 128 at the second connection 102, and having a single radial projection 210 rather than multiple projections 210(a), 210(b), 210(c) may arise for a number of different reasons.

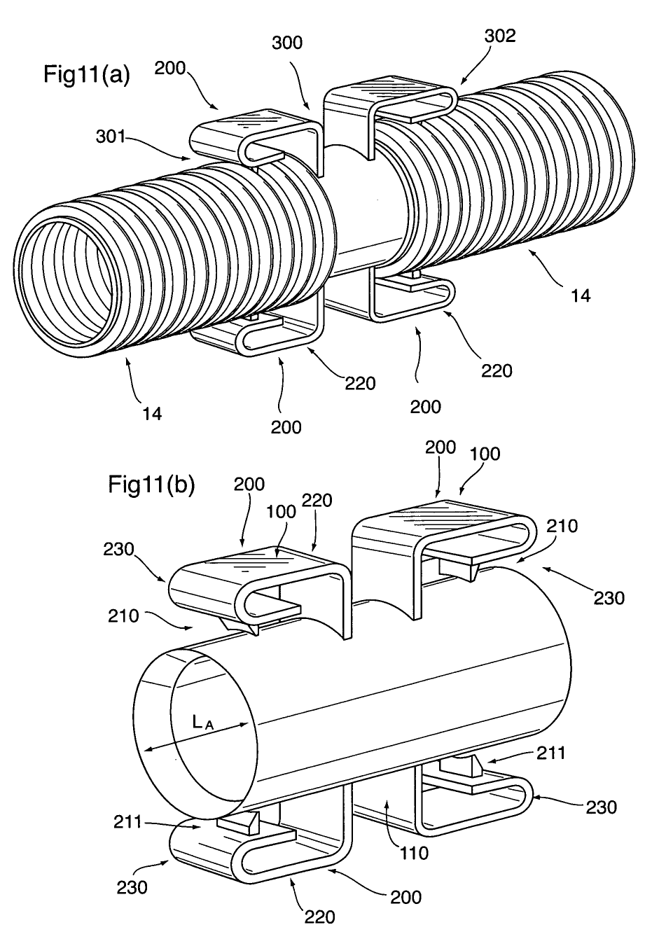

FIGS. 11(a) and 11(b) show a still further preferred embodiment of the present invention. In this embodiment, the securing mechanism 200 has a c-shaped resilient member 220 carrying radial projections 210 and opposed radial projections 211. The c-shaped resilient member 220 may have advantages such as by being more resilient in view of the larger mass. The c-shaped resilient member 220 may also have advantages by having a pressure surface, shown generally by reference numeral 230 and FIG. 11(b). The pressure surface 230 is a surface upon which the user may easily apply pressure to bias the radial projections 210, 211 radially outwardly away from the longitudinal axis L_{A} of the air tube 110 so that the radial projections 210, 211 may disengage the at least one corrugation 20, thereby releasing the hose 14 from the securing mechanism 200. It is apparent that in FIG. 11(a), the pressure would be applied to the pressure surfaces 230 in a direction radially outwardly from the longitudinal axis L_{A} of the air tube 110.

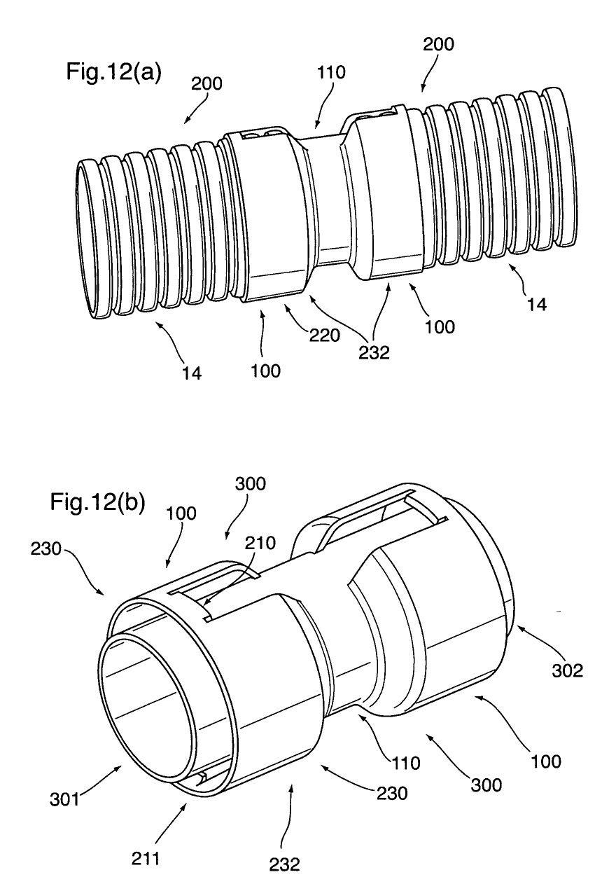

FIGS. 12(a), 12(b) and 12(c) illustrate a further embodiment of the present invention where the resilient member 220 has a resilient curved portion 232. Preferably, the resilient curved portion 232 extends at least 180° around the air tube 110 and more preferably 360° completely around the air tube 110. The resilient curve portion 232 of the resilient member 220 also has pressure surfaces 230 shown best in FIG. 12(b) and radial projections 210, and opposed radial projections 211. As will be apparent, such as from FIG. 12(b), applying inwardly radial pressure at least one of the pressure surfaces 230, and preferably at both of the opposed pressure surfaces 230, will bias the radial projection 210, 211 radially outwardly to disengage the corrugations 20. A similar connection 150 may appear at the second end 302 of the fitting 300 (shown in FIG. 12(b)).

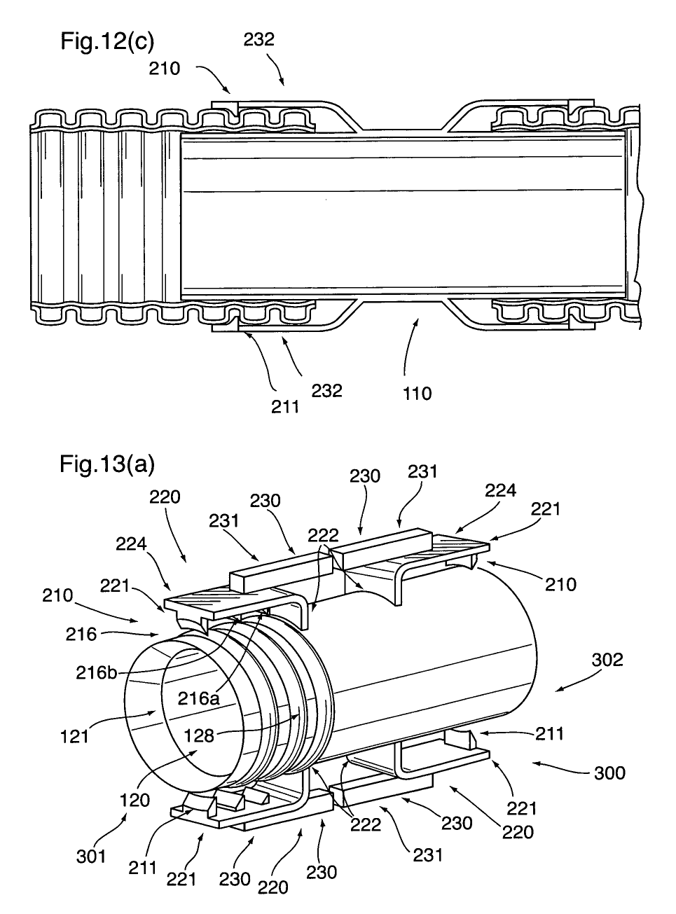

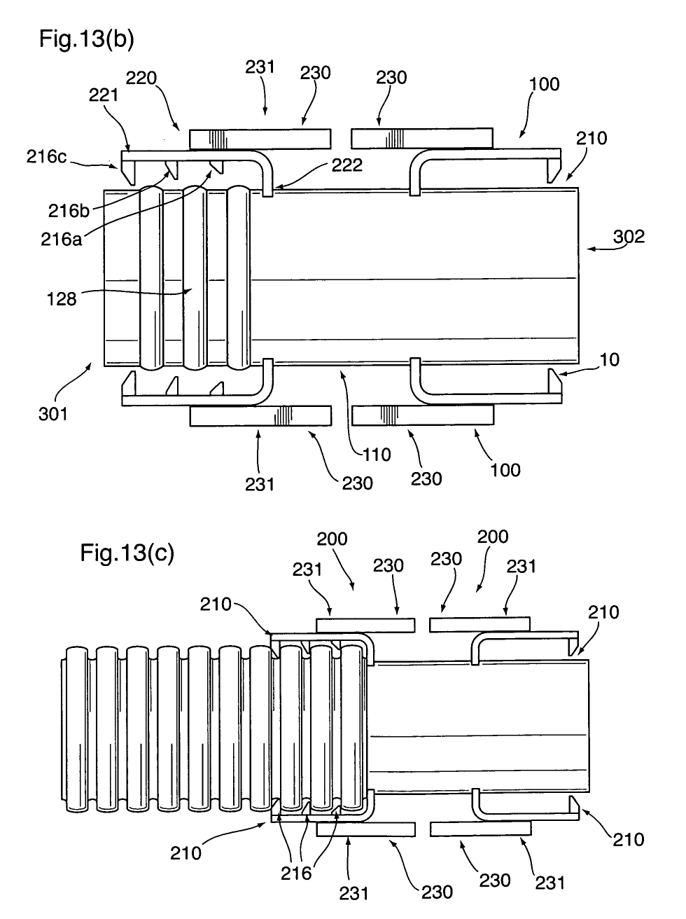

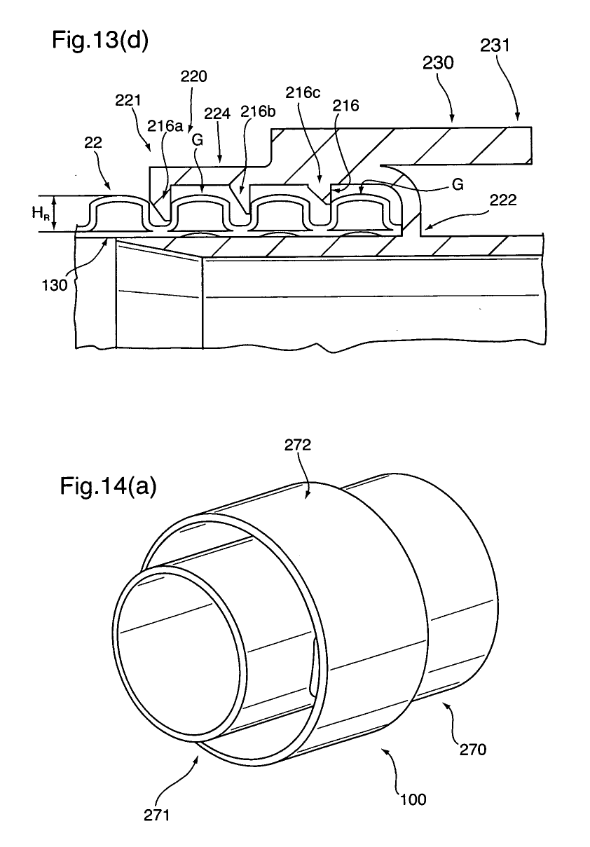

FIGS. 13(a), 13(b) and 13(c) show a still further preferred embodiment of the present invention. In FIGS. 13(a) to 13(d), the connections 100 have a lever 231 which carries the pressure surfaces 230. The levers 231 carry the pressure surfaces 230 at a location remote from the radial projections 210, 211. When the user applies pressure to pressure surfaces 231, this causes the radial projections 210, 211 to disengage the at least one corrugation 20.

In a preferred embodiment illustrated in FIGS. 13(a) to 13(d), this is accomplished, at least in part, because the lever 231 extends from the arm 224 of the resilient member 220 over the second end 222 of the resilient member 220, which is attached to the air tube 110. In this way, the lever 231 acts as a first class lever with the second connection 222 as the fulcrum. By the user applying pressure to the pressure surfaces 231 radially inwardly towards the air tube 110, the arm 224 and the resilient member 220 are moved about the second end 222 to raise the radial projection 210 and the opposed radial projections 211 away from the air tube 110 and out of the trough 22, disengaging from the corrugation 20 of the hose 14.

One of the advantages of the embodiment illustrated in FIGS. 13(a) to 13(d) is that the user may apply the radially inward force to the pressure surfaces 230 using the fingers from a single hand. In this way, the radial projection 210 and the opposed projections 211 may all be disengaged from the corrugations 20 of the hose 14 while the user has the other hand free to perform other functions, such as removing the first opening 121 of the air tube 110 from the hose 14. The user may also wish to apply pressure to the pressure surfaces 230 when inserting the first opening of the air tube 110 into the hose 14, whether or not the radial projections 210 have chamfered edges 212 as discussed above.

Furthermore, as also illustrated in FIGS. 13(a) to 13(d) to facilitate disengaging the radial projections 210 from the corrugations 20 of the hose 14, it is preferred that the radial projections 210 have different lengths, shown generally be reference numerals 216(a), 216(b) and 216(c).

Preferably, the longest radial projection 216(c) is furthest away from the second end 222 of the resilient member which acts as the fulcrum. This is the case because the first end 221 of the resilient member will move the furthest from the air tube 110 when pressure is applied to surface 230 such that the radial projection 216(c) closest to the first end 221 and the resilient member 220 can be the longest. The other differing length radial projections 216(a), 216(b), are corresponding shorter lengths representing the fact that when inwardly radial pressure is applied to pressure surfaces 230, the resilient member 220 will not move the same amount of distance upwardly about the second end 222 so that the differing link radial projections 216(a), 216(a) closer to the second end 222 could be of a shorter length.

In a further preferred embodiment, the length of each of the differing length radial projections may satisfy the following equation

DLRPₙ height=G+(H_{R}*n/N):

where DLRPₙ height represents the height of the differing length radial projection 216 with ₙ representing the sequence number from the second end 222 of the resilient member 220;

G represents the clearance between the top of the ridge 22 and the bottom of the arm 224

H_{R} represents the height of the ridge 22 from the outer surface 23 of the hose 14;

n represents the position of the differing length radial projection 216 from the second end 222 of the resilient member 220; and

N represents the total number of differing length radial projections carried by the arm 224.

As also illustrated in FIG. 13(b), in this preferred embodiment, a number of rings 128 will also be present on the surface 123 of the air tube 110. This is to facilitate a better airtight seal 130 as discussed above. Furthermore, as also discussed above, the centre line of the rings 128 will be a distance from the radial differing length radial projections 216 corresponding to one half of the width 36 of a corrugation 20.

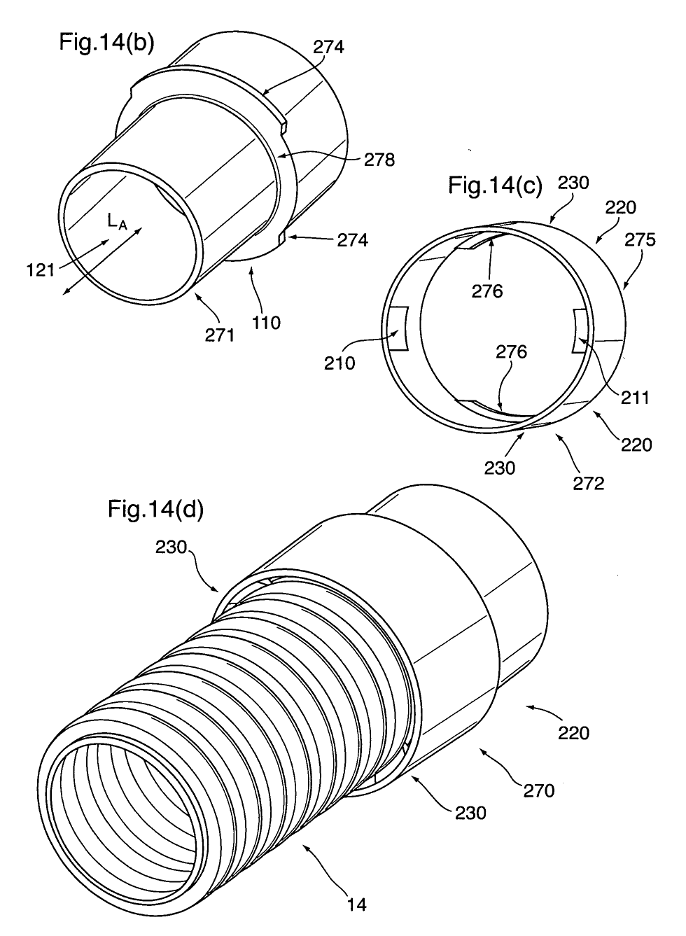

FIGS. 14(a), 14(b), 14(c) and 14(d) show a still further embodiment of the present invention where the connection 100 comprises two parts, shown collectively by reference numeral 270, with the first part of the two-part connection shown generally by reference 271 and the second part shown generally by reference numeral 272. The two parts 271, 272 are shown connected in FIG. 14(a). FIG. 14(b) shows the first part 271 and FIG. 14(c) shows the second part 272. As illustrated in FIG. 14(b), the first part 271 comprises the air tube 110 and the first opening 121 which can be inserted into a hose 14. The first part 271 also comprises locking tabs 274 at an axial position along the longitudinal axis L_{A} representing the full insertion of the first opening 121 of the air tube 110 into the hose 14. In other words, when the first opening 121 of the hose 110 is fully inserted into hose 14, the hose 14 will preferably abut against the tabs 274.

As illustrated in FIG. 14(c), the second part 272 will preferably have a securing ring 275. In a preferred embodiment, the securing ring 275 may also be resilient thereby corresponding to the resilient member 230. The securing ring 275 preferably has a radial projection 210 and an opposed radial projection 211 substantially intermediate the opposed locking notches 276. The locking notches 276 are sized to fit through the locking tabs 274. In this way, during operation, the securing ring 275 will initially be placed over the corrugated hose 14 such that the radial projections 210, 211 engage at least one of the corrugations of the hose 14. The first opening 121 of the air tube 110 will then be inserted into the hose 14 to position it which the hose 14 is abutting against the surface 278 of the locking tabs 274. The second part 272 can then be rotated such that the locking notches 276 can fit through the locking tabs 274 and the first part 272 can then be rotated so as to lock the first parts and second parts by the locking notches 276 becoming interlocked with the locking tabs 274. To facilitate movement of the second part 272 up and down the hose 14, it is preferred that the securing ring 275 be resilient such that radially inward pressure applied at the pressure surfaces 230 will cause the resilient securing ring 275 to resiliently deform outwards into an oval thereby radially moving the radial projections 210, 211 away from the longitudinal axis L_{A} of the air tube 110 and permitting movement of the resilient securing ring 275 up and down the hose 14.

It is understood that the connection 100 may be used to connect a hose 14 of various inner diameters I_{DC} to vacuum fittings 300. Typically, in North American residential installation, the hose 14 inner diameter I_{DC} will be 1.5″ to 2.5″ and more specifically about 2″. This range corresponds to the outer diameter of some rigid tubing 4 and also would be accommodated in most typical 2″×4″ wooden construction spaces, typical in North American residential construction. The connection 100 may also be used to connect hose 14 having larger inner diameters I_{DC} such as 2.5″ to 4″, as common in many commercial or industrial installations. The connection 100 may also be used to connect hose 14 having smaller inner diameters I_{DC}, such as 40 mm to 50 mm, and more specifically 40 mm to 45 mm, as may be used in European residential construction.

It is also understood that the same fitting 300 may have connections to connect to hoses 14 of different inner diameter I_{DC}. This could arise, for instance, where a vacuum system 10 extends to different remote locations permitting hose 14 of differing, and often decreasing, inner diameter I_{DC}, further from the vacuum source 3. In such cases, the outer diameter O_{DA} of the air tube 110 adjacent a first opening 121 would correspond to the inner diameter I_{DC} of a hose 14 to be connected to the first connection 101 at the first end 301 of a fitting 300, and, the outer diameter O_{DA} of the air tube 110 adjacent the second opening 122 would correspond to the inner diameter I_{DC} of the other hose 14 to be connected to the second connection 102 at the second end 302 of the fitting 300.

To the extent that a patentee may act as its own lexicographer under applicable law, it is hereby further directed that all words appearing in the claims section, except for the above defined words, shall take on their ordinary, plain and accustomed meanings (as generally evidenced, inter alia, by dictionaries and/or technical lexicons), and shall not be considered to be specially defined in this specification. Notwithstanding this limitation on the inference of “special definitions,” the specification may be used to evidence the appropriate, ordinary, plain and accustomed meanings (as generally evidenced, inter alia, by dictionaries and/or technical lexicons), in the situation where a word or term used in the claims has more than one pre-established meaning and the specification is helpful in choosing between the alternatives.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments, which are functional, electrical or mechanical equivalents of the specific embodiments and features that have been described and illustrated herein.

The embodiments of the invention in which an exclusive property or privilege is claimed are defined as follows:

1. A connection to connect a vacuum fitting to a corrugated hose having an inner diameter and corrugations on the outer surface, said connection comprising:
an air tube defining an air channel and having a first opening, said air tube having an outer diameter corresponding to the inner diameter of the corrugated hose to create an air tight seal when the first opening of said air tube is inserted into the corrugated hose and the air channel is in vacuum communication with the corrugated hose;
a securing mechanism for releasably securing the vacuum fitting to the corrugated hose, said securing mechanism releasably engaging at least one corrugation of the corrugated hose to secure the vacuum fitting to the corrugated hose when the first opening of the air tube is inserted into the corrugated hose.

2. The connection as defined in claim 1 wherein the first opening has a transition phase to channel air flow and debris from the corrugated pipe to the air channel.

3. The connection as defined in claim 2 wherein the transition phase comprises a chamfered edge extending from the first opening along a longitudinal axis of the air tube and having an angle of less than 60° with respect to the longitudinal axis.

4. The connection as defined in claim 1 wherein the first opening is at a first end of the vacuum fitting and wherein the air tube has a second opening at a second end of the vacuum fitting, said second opening communicating with the first opening through the air channel; and
wherein the second opening is in vacuum communication with the hose when the first opening of the air tube is inserted into the corrugated hose.

5. The connection as defined in claim 1 wherein the corrugated pipe is a double wall blow molded hose having ridges and troughs on the outer surface and a substantially smooth walled inner surface.

6. The connection as defined in claim 1 wherein the vacuum fitting is selected from the group consisting of straight connectors, T-shaped connectors and short 90° adaptors.

7. The connection as defined in claim 1 wherein the air tube comprises a second opening communicating with the first opening through the air channel, said second opening having a PVC tube connection with an inner diameter corresponding to an outer diameter of a PVC tube to be connected to the second opening; and
wherein the fitting is a PVC pipe/corrugated pipe adaptor.

8. The connection as defined in claim 1 wherein the securing mechanism comprises a radial projection, said radial projection engaging at least one corrugation on the outer surface of the corrugated hose to releasably secure the vacuum fitting to the corrugated hose.

9. The connection as defined in claim 8 wherein the securing mechanism comprises a pressure surface, such that applying pressure at the pressure surface moves the radial projection to disengage the radial projection from the at least one corrugation.

10. The connection as defined in claim 9 wherein the securing mechanism comprises a lever carrying said pressure surface at a location remote from said radial projection; and
wherein user applied pressure at the pressure surface moves the radial projection to disengage the at least one corrugation.

11. The connection as define in claim 10 wherein the securing mechanism further comprises a resilient member carrying the radial projection; and
wherein the corrugations of the corrugated hose define ridges and troughs; and
wherein the radial projection projects substantially radially inwardly towards the air tube, and, the resilient member biases the radial projection into at least one trough of said at least one corrugation on the outer surface of the corrugated pipe.

12. The connection as defined in claim 11 wherein the resilient member comprises an arm having a first end and a second end;
wherein the radial projection is carried on the first end proximate the first opening and the second end is fixed to the air tube;
wherein the lever extends from the arm over the second end of the resilient member to carry the pressure surface at a location remote from the radial projection;
wherein user applied pressure at the pressure surface towards the air tube moves said arm about the second end to raise the radial projection from the at least one trough disengaging the securing mechanism from the at least one corrugation.

13. The connection as defined in claim 8 wherein the radial projection has a chamfered edge which engages the at least one corrugation when the corrugated hose is moved in an insertion direction inserting the air tube into the corrugated hose; and
wherein the radial projection resiliently moves over the corrugations of the hose as the corrugations engage the chamfered edge in the insertion direction.

14. The connection as defined in claim 13 wherein the radial projection has a locking edge which engages the corrugations when the corrugated hose is moved in a removal direction removing the air tube from the corrugated hose; and
wherein the locking edge engages the corrugations on the outer surface of the hose to resist movement of the hose in the removal direction.

15. The connection as defined in claim 12 wherein the radial projection has a chamfered edge which engages the at least one corrugation when the corrugated hose is moved in an insertion direction inserting the air tube into the corrugated hose; and
wherein the radial projection resiliently moves over the corrugations of the corrugated hose as the corrugations engage the chamfered edge in the insertion direction;
wherein the radial projection has a locking edge which engages the corrugations when the corrugated hose is moved in a removal direction removing the air tube from the corrugated hose; and
wherein the locking edge engages the corrugations of the outer surface of the hose to resist movement of the hose in the removal direction; and
wherein user applied pressure at the pressure surface towards the air tube moves the radial projection from the at least one trough of a corrugation against the biasing force of the resilient member to disengage the securing mechanism from the at least one corrugation and permit movement of the pipe in the removal direction.

16. The connection as define in claim 8 wherein the securing mechanism comprises:
a resilient curved portion extending at least 180° around the air tube with opposed pressure surface and carrying the radial projection substantially intermediate the opposed pressure points; and
wherein applying pressure at least one of the opposed pressure surface biases the radial projection radial outwardly to disengage the at least one corrugation.

17. The connection as defined in claim 16 wherein the resilient curved portion extends 360° around the air tube.

18. The connection as defined in claim 17 wherein the resilient curved portion carries an opposed radial projection substantially opposite the radial projection and substantially intermediate the opposed pressure surfaces; and
wherein applying inwardly radial pressure at the opposed pressure surfaces biases the radial projection and the opposed radial projection radially outwardly to disengage the at least one corrugation.

19. The connection as defined in claim 8 wherein the securing mechanism comprises two or more radial projections, each radial projection separated along a longitudinal axis of the air tube a distance corresponding to a length of a corrugation along a longitudinal axis of the corrugated hose.

20. The connection as defined in claim 19 wherein the securing mechanism further comprises a resilient member carrying the radial projection:
wherein the resilient member comprises an arm having a first end and a second end; and
wherein the two or more radial projections have successively increasing lengths along the longitudinal axis from the second end fixed to the air tube to the first end proximate the first opening.

21. The connection as defined in claim 8 wherein the air tube comprises at least one ring on an external surface thereof, and wherein the at least one ring engages the inner surface of the corrugated hose to radially outwardly deform the corrugated hose at a longitudinal location corresponding to a ridge on the outer surface of the corrugated hose.

22. A vacuum fitting for a central vacuum system, said vacuum fitting having a first end and comprising the connection as defined in claim 1 at the first end of the fitting for connecting the vacuum fitting to a corrugated hose.

23. A vacuum fitting for a central vacuum system, said vacuum fitting having a first end having a first connection corresponding to the connection defined in claim 4 for connecting the vacuum fitting to a first corrugated hose, and said fitting having a second end having a second connection corresponding to the connection defined in claim 4, wherein the first connection and the second connection share a common air tube and the second opening of the first connection is coincident with the first opening of the second connection and the second opening of the first connection is coincident with the first opening of the second connection.

24. A vacuum fitting for a central vacuum system, said fitting comprising:
a first end having a first connection for a corrugated hose, said connection comprising:
(a) an air tube defining an air channel and having a first opening, said air tube having an outer diameter corresponding to an inner diameter of the corrugated hose to create an air tight vacuum seal when the first opening of said air tube is inserted into the corrugated hose and the air channel is in vacuum communication with the corrugated hose;
(b) a first securing mechanism for releasably securing the first end of the vacuum fitting to the corrugated hose, said first securing mechanism releasably engaging at least one corrugation of the corrugated hose to secure the first end of the vacuum fitting to the corrugated hose when the first opening of the air tube is inserted into the corrugated hose;
a second end of the fitting, remote from the first end, and, in vacuum communication with the first end through the air channel of the air tube.

25. The vacuum fitting as defined in claim 24 further comprising a second connection at the second end for connection to another corrugated hose, said second connection comprising:
a second opening of the air tube communicating with the first opening through the air channel, the outer diameter of the air tube adjacent the second opening corresponding to an inner diameter of the other corrugated hose to create an air tight seal where the second opening of the air tube is inserted into the other corrugated hose and the air channel is in vacuum communication with the other corrugated hose; and
a second securing mechanism for releasably securing the second end of the vacuum fitting to the other corrugated hose, said second securing mechanism releasably engaging at least one corrugation of the other corrugated hose to secure the second end of the vacuum fitting to the other corrugated hose when the air tube is inserted into the other corrugated hose.
